(19) United States
(12) Patent Application Publication
(10) Pub. No.: US 2004/0048141 A1
(43) Pub. Date: Mar. 11, 2004

(54) Pem-fuel cell stack with a coolant distributor structure

(76) Inventors: Felix Blank, Konstanz (DE); Cosmas Heller, Ueberlingen (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/450,218

(22) PCT Filed: Dec. 1, 2001
(86) PCT No.: PCT/DE01/04518

(30) Foreign Application Priority Data
Dec. 12, 2000 (DE) 100 61 784.0

(51) Int. Cl. H01M 8/02; H01M 8/10; H01M 8/04; H01M 8/24

(52) U.S. Cl. 429/38; 429/26; 429/32; 429/13

(57) ABSTRACT

The invention relates to an electrochemical fuel cell stack, comprising at least one membrane-electrode unit (MEA) consisting of an anode, a cathode and an electrolyte membrane which is located between them, at least one gas distributor structure on the anode side, comprising an anode gas inlet area, an anode gas outlet area and channels for guiding the anode gas from the anode gas inlet area to the anode gas outlet area, said anode gas containing hydrogen and being un-wet or partially wet; at least one gas distributor structure on the cathode side, comprising a cathode gas inlet area, a cathode gas outlet area and channels for guiding the cathode gas from the cathode gas inlet area to the cathode gas outlet area, the cathode gas containing oxygen and being un-wet or partially wet; and a coolant distributor structure, comprising a coolant inlet area, a coolant outlet area and channels for guiding the coolant from the coolant inlet area to the coolant outlet area. According to the invention, the coolant inlet area and the cathode gas inlet area overlap each other at least partially. The coolant outlet area and the cathode gas outlet area also overlap each other at least partially, so that a temperature gradient with a temperature that increases from the inlet area to the outlet area can form along the coolant and cathode gas channels between the overlap areas in inlet and outlet areas.

The invention relates to an electrochemical fuel cell stack in accordance with the preamble of patent claim 1.

Fuel cell stacks in accordance with the prior art comprise at least one and usually a plurality of individual fuel cells which are stacked next to or on top of one another. A single cell comprises two distributor plates for distributing the fluids and a membrane electrode assembly, also known as MEA for short, arranged between the plates. An MEA comprises an anode, a cathode and a proton-conducting electrolyte membrane arranged therebetween. Proton transport from the anode to the cathode is ensured by means of the proton-conducting electrolyte membrane (PEM). The distributor plates have gas passages on the anode and cathode side (anode and cathode passages) for supplying and discharging the fuel-containing anode gas, e.g. hydrogen, and the oxygen-containing cathode gas, e.g. air.

To control the temperature of the fuel cell, there are cooling chambers within the stack, through which a liquid or gaseous cooling medium flows. These cooling chambers can be arranged at any desired locations within the stack and within an individual cell. By way of example, each individual cell may be assigned a cooling chamber. However, it is also possible for a plurality of individual cells to be assigned to a cooling chamber.

At the cathode, product water is formed in an electrochemical reaction. However, particularly at the cathode gas inlet where it enters the cathode passage, the MEA is subject to considerable removal of moisture. This removal of moisture is caused by the evaporation of water on account of the high temperatures which are produced in the electrochemical reaction and during current transport. This effect is made more intense by the electro-osmosis transport of hydrogen-water compounds, e.g. hydronium ions H(H₂O)₊, which transport water from the anode to the cathode. The MEA drying out leads to a reduction in the proton conductivity and therefore to a drop in the cell voltage and in the efficiency of the fuel cell.

To control the humidity of the cathode gas, U.S. Pat. No. 4,973,530 proposes a fuel cell stack which has a further medium, e.g. water, and therefore a further separate fluid circuit for controlling the humidity of the cathode gas. In this case, the distributor plates of adjacent fuel cells have two passage regions which adjoin one another and are in flow communication. In the first passage region, the cathode gas is passed to the MEA. After it has flowed through the first passage region, the cathode gas flows into the second passage region, where it is passed to a water-permeable membrane. Water is guided along the other side of this water-permeable membrane, so that the cathode gas can be humidified in this second passage region. In a further embodiment, U.S. Pat. No. 4,973,530 also discloses the simultaneous regulation of the humidity of the anode gas. This ensures a virtually uniform water concentration in the cathode gas and anode gas and a virtually uniform temperature within the fuel cell stack.

One drawback is that in this arrangement a further fluid circuit is required for continuous humidification of the cathode gas and anode gas. This results in further drawbacks in terms of achieving a compact form of the fuel cell stack. Compared to conventional fuel cell stacks, this concept also has drawbacks in terms of the reduced efficiency resulting from a smaller MEA surface area.

It is an object of the invention to provide a fuel cell stack with which it is possible to prevent the MEA from drying out without additional humidification of the cathode gas.

The object is achieved by the fuel cell stack as described in patent claim 1. The subclaims relate to advantageous embodiments of the invention and to a method for operating the fuel cell stack according to the invention.

In the fuel cell stack according to the invention, there is an at least partial overlap firstly between the region in which the cooling medium enters the fuel cell stack and the region in which the cathode gas enters the fuel cell stack. In addition, in the fuel cell stack according to the invention, there is secondly also an at least partial overlap between the region in which the cooling medium leaves the fuel cell stack and the region in which the cathode gas leaves the fuel cell stack. This results in a temperature gradient with a temperature which rises from the inlet region to the outlet region along the passages for distributing the cooling medium and the cathode gas. Therefore, in the fuel cell stack according to the invention, it is possible to ensure sufficient humidification of the cathode gas without the need for any further manufacturing technology measures. Consequently, the fuel cell stack according to the invention prevents the MEA from drying out. In particular, the cathode gas and the MEA are humidified by means of the product water generated in the fuel cell reactions. Further advantages are an improved efficiency and an increased long-term stability in the fuel cell.

In an advantageous embodiment of the invention, it is additionally possible for the region in which the anode gas enters the fuel cell stack and the inlet region of the cooling medium and cathode gas to at least partially overlap. Moreover, the outlet region of the anode gas may additionally at least partially overlap the outlet region of the cathode gas and cooling medium.

Of course, it is also possible for regions which are located between the inlet region and the outlet region and in which the cooling medium and the cathode gas are flowing to overlap one another.

The fuel cell stack according to the invention is advantageously operated with a gaseous cooling medium, preferably air, which has a significantly lower heat capacity than the liquid cooling media which are customarily used, such as for example water or glycol. If the cooling medium used were, for example, water, this would entail a considerable outlay in terms of cooling technology (e.g. a large cooler surface area), which would entail drawbacks in terms of the space required for and the manufacturing costs of the fuel cell stack. Moreover, a temperature gradient can be established more quickly in a gaseous cooling medium with a low heat capacity than in a liquid cooling medium with a high heat capacity. Consequently, faster and more accurate control of the temperature in the fuel cell stack is therefore possible. A further advantage of a gaseous cooling medium is the fact that the cooling capacity is the same in each individual fuel cell of the stack. This results from the fact that a high volumetric throughput of gaseous cooling medium is possible even if there is a high temperature difference between the inlet and outlet regions of the cooling medium. Furthermore, with a gaseous cooling medium it is possible to achieve cell voltages which are equal to or better than those achieved with a liquid cooling medium.

The cooling medium and the cathode gas advantageously flow in cocurrent through the fuel cell stack according to the invention. In terms of the fluid flow, in the present context cocurrent is to be understood as meaning that the flow of the cooling medium and the flow of the cathode gas have at least one three-dimensional direction component in which the two fluids flow in cocurrent.

To improve understanding of the invention, it should be noted at the present point that the main conversion of materials in the fuel cell reactions takes place in the inlet region where the cathode gas enters the fuel cell stack. That is also where the cathode gas is heated most strongly. However, in the fuel cell stack according to the invention it is this very region in which most heat is generated which is cooled most strongly as a result of the inventive overlaps between the inlet regions of the cooling medium and of the cathode gas.

Therefore, the cooling medium, which flows into the fuel cell stack at a low temperature, preferably ambient temperature (typically 23° C.), is heated as it flows along the cooling passage by the heat which is generated in the fuel cell reactions. The temperature at which the cooling medium flows out of the fuel cell stack is typically 65° C.

The unhumidified or partially humidified cathode gas which flows into the fuel cell stack has a low dew point and would dry out the MEA to a considerable extent if there were high temperatures at the cathode gas inlet (caused by the fuel cell reactions). The overlaps according to the invention, however, mean that the cathode gas which flows into the fuel cell stack is cooled to a considerable extent in the inlet region by means of the cooling medium and is therefore kept at a low temperature level. This prevents the MEA from drying out in the inlet region of the cathode gas.

The product water which is formed to an increasing extent in the fuel cell reactions raises the dew point of the cathode gas as it passes onward through the cathode gas passage. To ensure uniform humidification of the cathode gas and therefore uniform humidification of the MEA along the cathode gas passage, in an advantageous embodiment of the invention the local temperature of the cooling medium may be in the region of the local dew point temperature of the cathode gas. This can be achieved, for example, by running the cooling medium distributor structure in a suitable way between the inlet and the outlet from the fuel cell stack.

This results in uniform saturation of the cathode gas. This is achieved in particular by means of the inventive overlaps of the inlet regions of the cooling medium and of the cathode gas and the associated heat exchange between cooling medium and cathode gas, since this ensures that the local temperature in the cathode gas passage is in the region of the dew point temperature of the cathode gas.

If MEAs with a high water retention capacity, i.e. MEAs which do not have a great tendency to dry out, are used, the local temperature of the cathode gas and of the MEA may also be greater than the local dew point temperature. In this case, the cooling medium used may also be a liquid cooling medium, but in this case the temperature level of the cooling medium should be higher than in the case of a gaseous cooling medium.

However, it is also possible for the dew point temperature of the anode gas which enters the fuel cell stack to be greater than the inlet temperature of the cooling medium. As a result, liquid water is formed in particular in the cooler inlet region of the anode gas passage, with the result that the MEA can be moistened.

Furthermore, it is possible to match the heat exchange between the cathode gas and the cooling medium to the various operating states of the fuel cell in order to optimize the cell-internal temperature gradient along the cathode gas passage. This matching can be effected by locally limited measures in the region of the overlap of cooling medium inlet region and cathode gas inlet region or of the overlap of cooling medium outlet region and cathode gas outlet region or, as a complementary measure, in the remaining region of the cell. These measures may, for example, consist in matching the geometry in terms of the passages. In this case, it is possible in particular to spatially vary the passage cross section, the number of passages per unit area or the arrangement of the passages. Further possible geometry-matching measures involve influencing the contact surface area by using ribs, webs, grooves or needles or the like in the flow passages.

A further possible measure consists in the targeted three-dimensional use of materials with special heat-conducting properties. By way of example, a material with a good thermal conductivity may be present in the region of strong cooling in the inlet region of the cooling medium and/or a material of poor thermal conductivity may be present in the remaining region of the cell. The materials may be applied in layer form to the surface of the passages or introduced into the carrier material itself.

By using one or a combination of the measures listed, it is possible, for example, to ensure a high level of heat exchange between cathode gas and cooling medium and therefore relatively intensive cooling of the fuel cell in the inlet region of the cooling medium. Moreover, in this way the local temperature of the cathode gas can be matched to the local dew point temperature of the cathode gas.

The invention is explained in more detail on the basis of exemplary embodiments and with reference to drawings, in which:

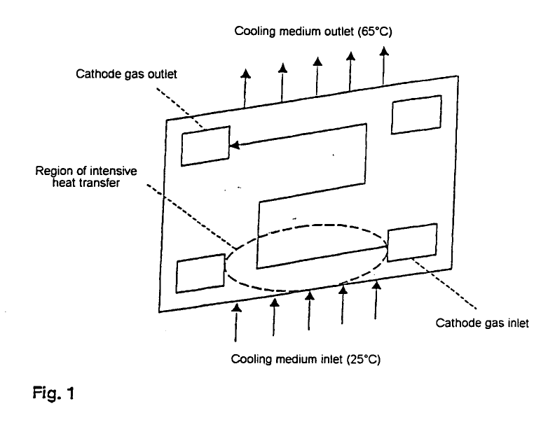

FIG. 1-3 each show embodiments of the fuel cell stack according to the invention,

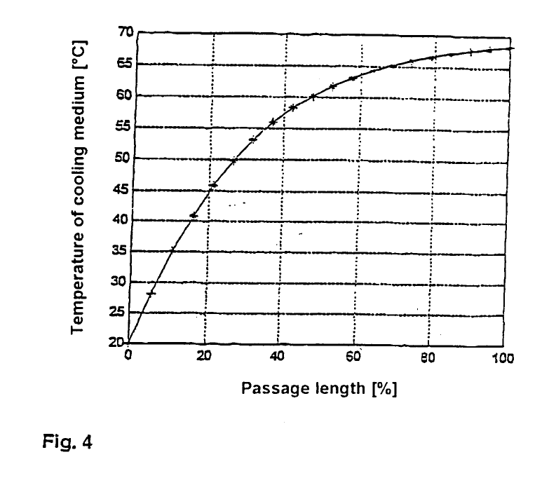

FIG. 4 shows an example of the profile of the cooling medium temperature from the inlet to the outlet from a fuel cell stack according to the invention,

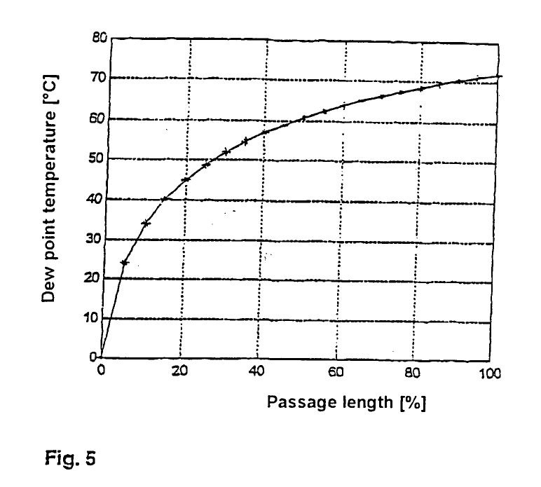

FIG. 5 shows an example of the profile of the dew point temperature along the cathode passage of a fuel cell stack according to the invention,

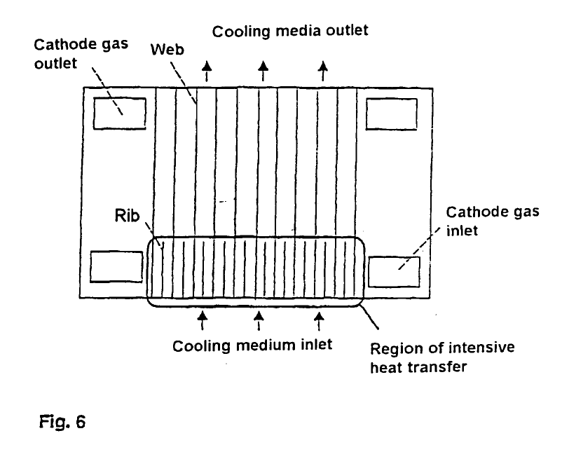

FIG. 6 shows an embodiment of the fuel cell stack according to the invention with a locally matched passage geometry in the inlet region,

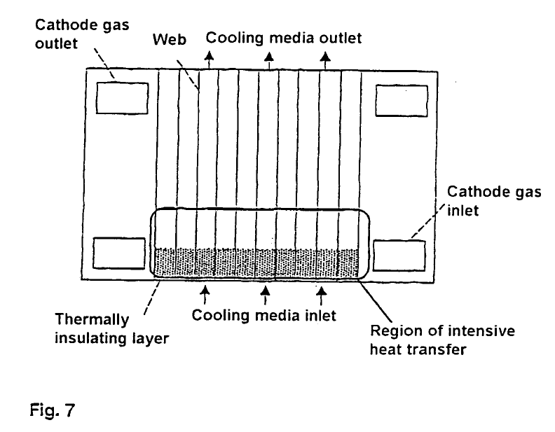

FIG. 7 shows an embodiment of the fuel cell stack according to the invention with locally matched use of thermally conductive/thermally insulating materials.

FIG. 1 diagrammatically depicts a first embodiment of the fuel cell stack according to the invention. The figure illustrates a plate, for example made from metal, with a cathode-side gas distributor structure for the cathode gas machined into its surface. The gas distributor structure is only diagrammatically indicated in this figure. It comprises one or more passages in serpentine or meandering form, as are known per se to the person skilled in the art. The cathode gas enters the cell via an aperture, passes through the flow passage(s) and emerges again from the cell at the diagonally opposite aperture.

In the context of the present invention, the terms “inlet region” and “outlet region” of a fluid are to be understood as meaning not only the immediate vicinity of the apertures but also their immediate surrounding area, specifically measured in the direction of fluid flow. For example, in the example illustrated the section of the flow passage from the last change of direction to the aperture also belongs to the cathode gas inlet region.

As can be seen from the drawing, in this embodiment the cooling medium enters the cell over substantially the entire edge length of the plate and flows in cross-current with respect to the cathode gas (the cooling medium flows on a distributor structure on the rear side of the plate illustrated). The resulting direction of flow of cathode gas and cooling medium is in this case nevertheless the same, and consequently in this case too there is cocurrent flow of cathode gas and cooling medium. Significant parts of the cooling medium inlet region and cathode gas inlet region overlap one another. The region of the overlap, in which most of the heat transfer between cathode gas and cooling medium takes place, is circled. The circling illustrated is given purely by way of example and is intended to indicate the region where the heat transfer is most intensive. Of course, heat transfer also takes place in other regions (not shown) of the overlap. In this embodiment, the cooling medium used is ambient air.

Typical temperatures of the cathode gas and cooling medium at the inlet and outlet are also shown in the figure. It can be seen that the temperature differences between inlet and outlet are relatively high for both fluids compared to known fuel cells. The temperature differences are in each case in the range from 30 to 45° C.

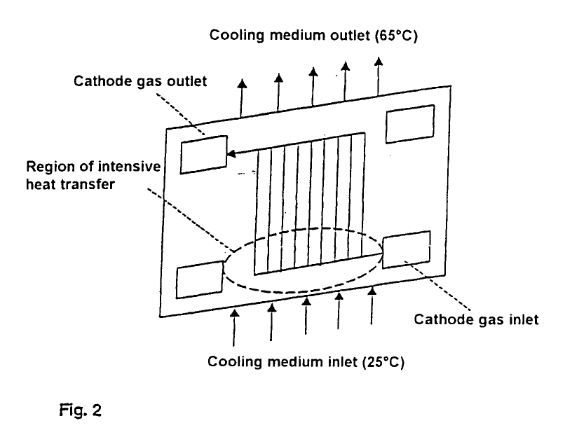

A further inventive embodiment is shown in FIG. 2. This differs from the embodiment illustrated in FIG. 1 substantially only by virtue of having a different gas distributor structure. This structure is in this case designed as a parallel gas distributor structure. The gaseous cooling medium (e.g. ambient air) enters the cell over substantially the entire edge length of the plate and flows in cocurrent with respect to the cathode gas (the cooling medium flows on a distributor structure on the rear side of the plate illustrated). Significant parts of the inlet region of the cooling medium and the inlet region of the cathode gas overlap one another and significant parts of the outlet region of the cooling medium and the outlet region of the cathode gas overlap one another.

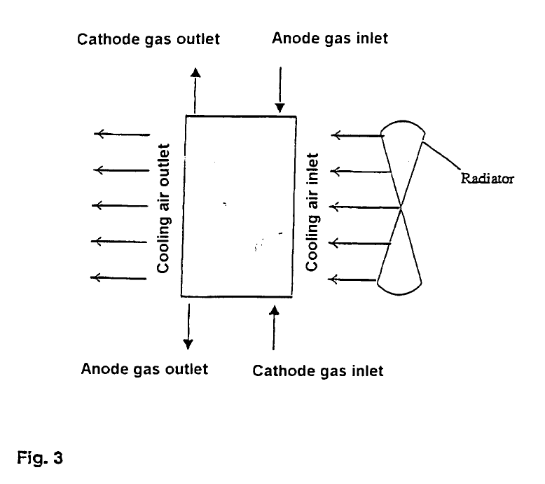

The air cooling as provided in the embodiment shown in FIG. 1 or 2 can advantageously be effected by means of a radiator. A design which is suitable for this purpose is shown in FIG. 3. The radiator is arranged immediately in front of the fuel cell stack and blows the air into the cooling passages or cooling chambers of the fuel cell stack. In a further embodiment (not shown here), the cooling air which is to be fed to the stack may also be conveyed into the stack from the radiator via a line.

FIG. 4 shows an example of the profile of the temperature of the cooling medium from the inlet to the outlet from the fuel cell stack according to the invention. In this case, the cooling medium temperature is plotted against the percentage length of the cooling passage between inlet and outlet from the fuel cell stack. The profile of the temperature substantially results from the uptake of the heat generated at the MEA in the fuel cell reactions which have been described. The profile of the temperature can be altered by varying the cooling medium distributor structure. A further possible way of influencing the temperature profile of the cooling medium is to change the heat capacity of the cooling medium.

FIG. 5 shows an example of the profile of the temperature of the dew point along the cathode gas passage of a fuel cell stack according to the invention. The figure plots the temperature against the percentage length of the cathode gas passage from the inlet to the fuel cell stack to the outlet from the fuel cell stack. As has been mentioned in the introduction to the description, the increase in the dew point temperature is caused by the product water which forms along the cathode gas passage.

It is clear from a comparison of FIG. 4 and FIG. 5 that the temperature of the cooling medium is in the region of the dew point temperature of the cathode gas over the entire length of the passage. This can be achieved by means of the inventive overlap of cooling medium inlet region and cathode gas inlet region. Both temperature curves have an approximately logarithmic profile. For example, at a percentage passage length of 60%, the local temperature of the cooling medium is approx. 63° C. and the local dew point temperature of the cathode gas is approx. 64° C. At a percentage passage length of 20%, the local temperature of the cooling medium is approx. 45° C. and the local dew point temperature of the cathode gas is likewise approx. 45° C.

FIG. 6 shows a further embodiment according to the invention. This figure illustrates a plate with, on its side which is not visible when observing the figure, a gas distributor structure for guiding the cathode gas illustrated in FIG. 1 or 2. The distributor structure for the cooling medium is illustrated on the side which is visible in the figure. It is possible to see the individual, parallel passages which are separated from one another by webs. The cathode gas enters the cell via an aperture in the plate, passes through the flow passage(s)—not visible here—and emerges again from the cell at the diagonally opposite aperture. The cooling medium enters the cooling passages at the bottom edge of the plate and leaves them at the opposite edge. The region of the overlap between cooling medium inlet region and cathode gas inlet region, in which most of the heat exchange takes place, is circled. In this overlap region, there are additional ribs inside the passages in order to increase the contact surface area. As a result, the heat exchange between cooling medium and cathode gas is increased in this region.

FIG. 7 shows an embodiment of the invention which varies the local heat exchange over the cell surface area by using additional measures. The structure of the plate, with the exception of the absence of the ribs in the region of the heat exchange, corresponds to that shown in FIG. 6, and for that reason reference is made to FIG. 6 in order to avoid repetition. As an additional measure, there is a thermally insulating layer on the passage surface within the region of overlap between cooling medium inlet region and cathode gas inlet region. In this region, the heat exchange can be increased by suitably selecting the layer thickness and layer material, in order in this way to optimize the formation of a temperature gradient. This layer may, for example, be a self-supporting layer or film which is bonded to the surface. However, it is also possible to apply a thin coating or to introduce the additional material directly into the carrier layer.

In a further embodiment (not shown), in the device shown in FIG. 6 materials of good thermal conductivity may be present in the region of overlap between cooling medium inlet region and cathode gas inlet region, in order to further improve the heat exchange between cathode gas and cooling medium in this region.

In another embodiment, in the device shown in FIG. 6 or 7, thermally insulating materials can be inserted in the region outside the overlap between cooling medium inlet region and cathode gas inlet region.

The measures described therefore make it possible to optimally match the temperature of the cooling medium to the dew point temperature of the cathode gas, so that optimum humidification of the cathode gas is ensured, thereby preventing the MEA from drying out.

All the measures which are shown in FIG. 6 and 7 and have been described in those figures in connection with the passages for guiding the cooling medium may also be applied in the same way to the passages for guiding the cathode gas.

The profile of the passages of the anode gas within the fuel cell stack is not shown for the sake of clarity.

1. An electrochemical fuel cell stack, having
at least one membrane electrode assembly (MEA) comprising an anode, a cathode and an electrolyte membrane arranged between them,
at least one anode-side gas distributor structure having an anode gas inlet region, an anode gas outlet region and passages for guiding the anode gas from the anode gas inlet region to the anode gas outlet region, the anode gas containing hydrogen and being unhumidified or partially humidified,
at least one cathode-side gas distributor structure having a cathode gas inlet region, a cathode gas outlet region and passages for guiding the cathode gas from the cathode gas inlet region to the cathode gas outlet region, the cathode gas containing oxygen and being unhumidified or partially humidified;
a cooling medium distributor structure having a cooling medium inlet region, a cooling medium outlet region and passages for guiding the cooling medium from the cooling medium inlet region to the cooling medium outlet region;
characterized in that cooling medium inlet region and cathode gas inlet region at least partially overlap, and in that cooling medium outlet region and cathode gas outlet region at least partially overlap, so that a temperature gradient with a temperature which rises from the inlet region to the outlet region can form along the passages for the cooling medium and the cathode gas between the regions of the overlaps in the inlet and outlet regions.

2. The electrochemical fuel cell stack as claimed in claim 1, characterized in that the local temperature of the cooling medium along the passages between the overlaps in the inlet region and the overlaps in the outlet region is in the region of the dew point temperature of the cathode gas.

3. The electrochemical fuel cell stack as claimed in one of the preceding claims, characterized in that the anode gas inlet region is additionally located in the region of the overlap between the inlet regions and the anode gas outlet region is additionally located in the region of the overlap between the outlet regions.

4. The electrochemical fuel cell stack as claimed in one of the preceding claims, characterized in that the geometry of the passages in the region of the overlap between the inlet regions and/or in the region of the overlap between the outlet regions differs from the geometry of the passages in the regions outside the overlap.

5. The electrochemical fuel cell stack as claimed in claim 4, characterized in that the geometry of the passages in the region of the overlap between the inlet regions and/or in the region of the overlap between the outlet regions differs from the remaining regions outside the overlap in terms of the passage arrangement, passage cross section, number of passages per unit area, additional ribs, webs, grooves or needles.

6. The electrochemical fuel cell stack as claimed in patent claim 4 or 5, characterized in that in the region of the overlap between the inlet regions and in the region of the overlap between the outlet regions, in the heat transfer path between cooling medium and cathode gas, there are materials which differ from the materials used outside the overlap in terms of their thermal conduction properties.

7. The electrochemical fuel cell stack as claimed in one of the preceding claims, characterized in that the cathode-side gas distributor structure and the cooling medium gas distributor structure are formed in such a manner that the cathode gas and the cooling medium are passed in cocurrent.

8. The electrochemical fuel cell stack as claimed in claim 7, characterized in that the anode-side gas distributor structure is formed in such a manner that the anode gas is passed in cocurrent with respect to the cathode gas and the cooling medium.

9. A method for operating the electrochemical fuel cell stack as claimed in one of the preceding claims, characterized in that the cooling medium used is a gas.
